(19) United States
(12) Patent Application Publication
(10) Pub. No.: US 2012/0087148 A1
(43) Pub. Date: Apr. 12, 2012

(54) Backlight Module and Display Device and Electronic Device Using the Same

(75) Inventors: Yang-Po Chiu, Taipei (TW); Yi-Hsiu Lee, Taipei (TW); Chia-Hsin Yang, Taipei (TW)

(73) Assignee: ASUSTEK COMPUTER INC., Taipei (TW)

(21) Appl. No.: 13/239,828

(22) Filed: Sep. 22, 2011

(30) Foreign Application Priority Data
Oct. 8, 2010 (TW) 99134448

(51) Int. Cl. F21V 13/04; F21V 7/00; G09F 13/04

(52) U.S. Cl. 362/607; 362/613; 362/609; 362/608

(57) ABSTRACT

A backlight module for a display device is provided. The backlight module mainly includes a light guide plate and a first quantity of light emitting elements. The light guide plate includes a first incident plane with a first length. Each of the light emitting elements emits light to form a specific emitting region and is disposed at a position away from the first incident plane in a first distance, and a first interval is between each adjacent light emitting elements. The first interval equals to the ratio of the first length to the first quantity, and the ratio is between eight and forty. The non-intersection area of the emitting region of each two adjacent light emitting elements is outside the display area of the display device.

### CROSS-REFERENCES TO RELATED APPLICATIONS

This non-provisional application claims priority under 35 U.S.C. §119(a) on Patent Application No. 99134448 filed in Taiwan, R.O.C. on Oct. 10, 2010, the entire contents of which are hereby incorporated by reference.

### BACKGROUND OF THE INVENTION

1. Field of the Invention

The disclosure relates to a backlight module and, more particularly, to a backlight module adapted to an electronic device.

2. Description of the Related Art

With the price decreasing, the liquid crystal display (LCD) gradually takes place of the conventional cathode ray tube (CRT) display and is widely used. The LCD is now applied to monitors of a notebook computer, a mobile telephone, a personal computer or even a television. The liquid crystal molecule cannot emit light by itself so the LCD needs be provided the light source by a backlight module.

A cold cathode fluorescent lamp (CCFL) is used as a light source of a conventional backlight module. When the light source is disposed below the LCD panel, it is called a direct-light-type backlight module. However, due to the environmental protection and the pursuit of thinning, the CCFL containing mercury is gradually replaced by the light emitting diode (LED). Additionally, the light source of the backlight module is disposed at a side instead of the bottom to make the dimension of the LCD module thinner. A light guide plate is used to change the direction of the light emitted from the side to form the area light source for the LCD panel, and it is called a side-light-type backlight module.

FIG. 1 is a schematic diagram showing a conventional backlight module. In the conventional backlight module 1, light emitting elements 12 are directly attached to a first incident plane 111 of a light guide plate 11 to avoid leaking light. Each of the light emitting elements 12 emits light to form a specific emitting region 121. The emitting regions 121 do not intersect with each other near the first incident plane 111. The size of the light guide plate 11 needs to be increased to avoid the brightness inuniformity of the display and further to avoid producing the dark area 15 below the display area. In order to decrease the dark area 15, the interval between the adjacent light emitting elements 12 needs to be appropriately reduced. Thus, the area of the light guide plate 11 is not increased too much, so as to save the material cost of the light guide plate 11.

The conventional backlight module 1 needs a big size of a light guide plate 11 and a large number of light emitting elements 12, which not only consumes much power and material, but also affects the thinner design of the display.

### BRIEF SUMMARY OF THE INVENTION

A backlight module adapted to a display is provided. The backlight module includes a light guide plate and a first quantity of light emitting elements. The light guide plate includes a first incident plane with a first length. Each light emitting element is disposed at a position away from the first incident plane with in a first distance. A first interval is between each two adjacent light emitting elements. Each light emitting element emits light to form a specific emitting region. The first interval equals to the ratio of the first length to the first quantity, the ratio is between eight and forty. A non-intersection area of the emitting region of each two adjacent light emitting elements is outside the display area.

A display device including a display area and the backlight module is provided. The backlight module is disposed below the display area. Moreover, an electronic device including a body, a display part and the backlight module is further provided. The body includes a keyboard and a motherboard. The display part is electrically connected to the body and shows information from the body at the display area. The backlight module is disposed in the display part and below the display area.

In the conventional backlight module, the light emitting elements are directly attached to the incident plane of the light guide plate. In the embodiment of the disclosure, by increasing the distance between the light emitting elements and the light guide plate, the usage amount of the light emitting elements is decreased, and the brightness and brightness uniformity of the display area are improved.

These and other features, aspects and advantages of the present disclosure will become better understood with regard to the following description, appended claims, and accompanying drawings.

### BRIEF DESCRIPTION OF THE DRAWINGS

FIG. 1 is a schematic diagram showing a conventional backlight module;

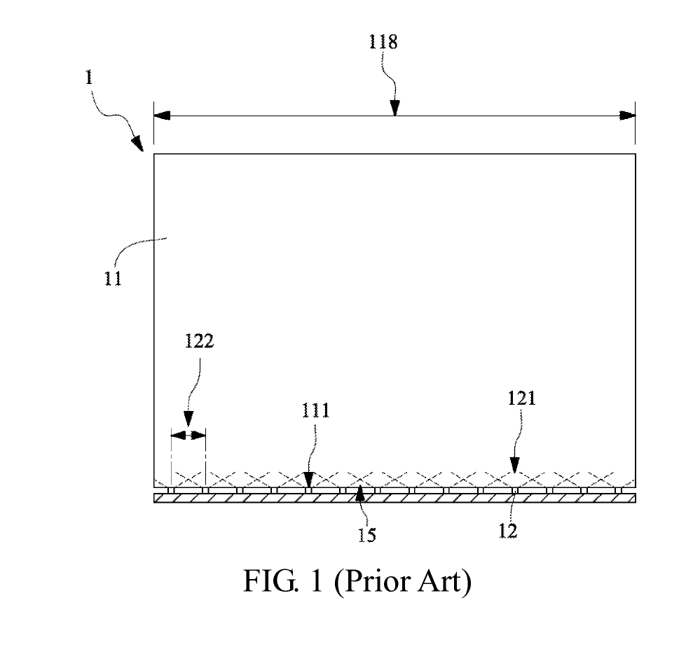

FIG. 2 is a schematic diagram showing a backlight module in a first embodiment to a fifth embodiment of the disclosure;

FIG. 3 is a schematic diagram showing a backlight module in a sixth embodiment of the disclosure;

FIG. 4 is a schematic diagram showing a backlight module in a seventh embodiment of the disclosure;

FIG. 5 is a schematic diagram showing a backlight module in an eighth embodiment of the disclosure; and

FIG. 6 is a sectional schematic diagram showing a backlight module in a ninth embodiment of the disclosure.

### DETAILED DESCRIPTION OF THE EMBODIMENTS

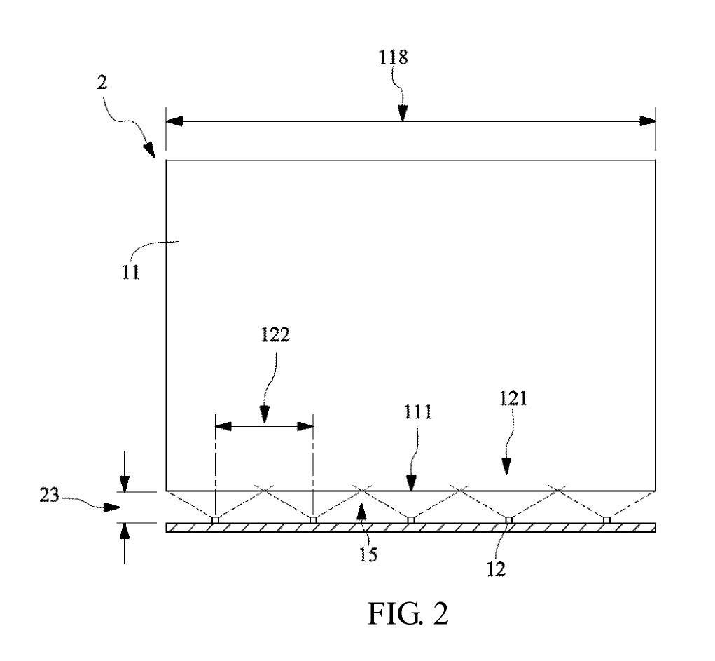

FIG. 2 is a schematic diagram showing a backlight module in a first embodiment of the disclosure. The backlight module 2 includes a light guide plate 11 and a first quantity of LEDs 12. The light guide plate 11 includes a first incident plane 111 with a first length 118. Moreover, each light emitting element 12 emits light to form a specific emitting region 121. Each light emitting elements 12 is disposed at a position away from the first incident plane 111 with a first distance 23. A first interval 122 is between each two adjacent light emitting elements 12. The first interval 122 equals to the ratio of the first length 118 to the first quantity, and its value is between eight and forty. A non-intersection area of the emitting region 121 of any two adjacent light emitting elements 12 is outside the display area of the display.

In the first embodiment, the backlight module is adapted to a 13.3-inch LCD, and a LED is used as the light emitting elements 12. The first length 118 of the first incident plane 111 of the light guide plate 11 is 304 mm. After increasing the first distance 23 between the light emitting elements 12 and the first incident plane 111, only eight light emitting elements 12 are needed, the LCD can be provided with enough brightness and the brightness uniformity. That is, the first interval between the two adjacent light emitting elements 12 is 38 mm (which is equal to the ratio of the first length 304 mm to eight light emitting elements, that is, 304 divided by 8).

Compared with the backlight module 1 of the conventional 13.3-inch LCD, about forty light emitting elements 12 are needed, and the first interval between the two adjacent light emitting elements 12 is 7.6 mm, the amount of the light emitting elements 12 of the first embodiment is reduced by eighty percent in the disclosure.

In the second embodiment, the backlight module is also adapted to a 13.3-inch LCD. The first length 118 of the first incident plane 111 of the light guide plate 11 in the embodiment is 304 mm. After increasing the first distance 23 between the light emitting elements 12 and the first incident plane 111, only 10 light emitting elements 12 are needed, the LCD can be provided with enough brightness and the brightness uniformity. That is, the first interval between the two adjacent light emitting elements 12 is 30.4 mm (which is equal to the ratio of the first length 304 mm to ten light emitting elements, that is, 304 divided by 10). Compared with the backlight module 1 of the conventional 13.3-inch LCD, the amount of the light emitting elements 12 is reduced by seventy five percent.

In the third embodiment, the backlight module is also adapted to a 13.3-inch LCD. The first length 118 of the first incident plane 111 of the light guide plate 11 is 304 mm. After increasing the first distance 23 between the light emitting elements 12 and the first incident plane 111, only 30 light emitting elements 12 are needed, the LCD can be provided with enough brightness and the brightness uniformity. That is, the first interval between the two adjacent light emitting elements 12 is 10.1 mm (which is equal to the ratio of the first length 304 mm to thirty light emitting elements, that is, 304 divided by 30). Compared with the backlight module 1 of the conventional 13.3-inch LCD, the amount of the light emitting elements 12 is reduced by twenty five percent.

In the fourth embodiment, the backlight module is adapted to a 15.6-inch LCD. The first length 118 of the first incident plane 111 of the light guide plate 11 is 335 mm. After increasing the first distance 23 between the light emitting elements 12 and the first incident plane 111, only 23 light emitting elements 12 are needed, the LCD can be provided with enough brightness and the brightness uniformity. That is, the first interval between the two adjacent light emitting elements 12 is 14.6 mm (which is equal to the ratio of the first length 335 mm to twenty-three light emitting elements, that is, 335 divided by 23). Compared with the backlight module 1 of the conventional 13.3-inch LCD, the amount of the light emitting elements 12 is reduced by twenty five percent.

Compared with the backlight module 1 of the conventional 15.6-inch LCD, about 48 light emitting elements 12 are needed, the first interval between the two adjacent light emitting elements 12 is 6.9 mm, the amount of the light emitting elements 12 of the fourth embodiment is reduced by fifty two percent in the disclosure.

In the fifth embodiment, the backlight module is adapted to a 20-inch LCD. The first length 118 of the first incident plane 111 of the light guide plate 11 is 430 mm. After increasing the first distance 23 between the light emitting elements 12 and the first incident plane 111, only 40 light emitting elements 12 are needed, the LCD can be provided with enough brightness and the brightness uniformity. That is, the first interval between the two adjacent light emitting elements 12 is 10.7 mm (which is equal to the ratio of the first length 403 mm to forty light emitting elements, that is, 403 divided by 40).

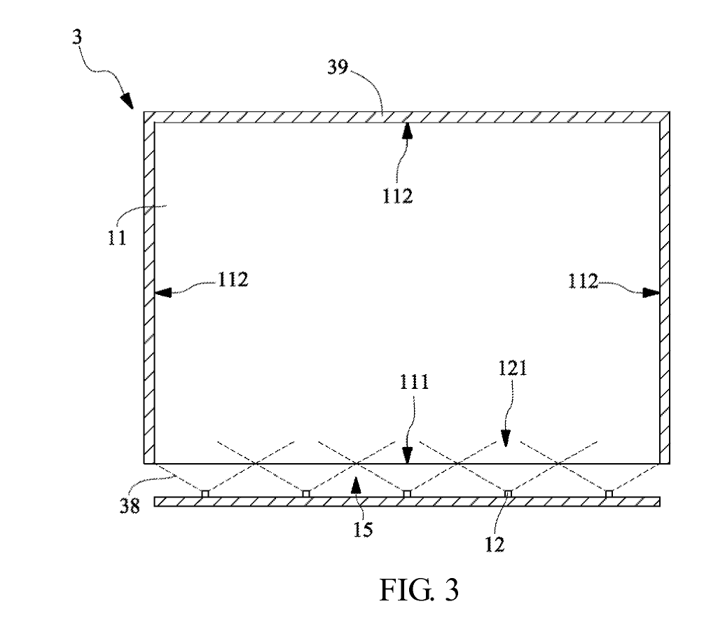

FIG. 3 is a schematic diagram showing a backlight module in a sixth embodiment of the disclosure. The difference between the sixth embodiment and the embodiments above is that a second incident plane 112 of the light guide plate 11 is covered with a reflecting layer 39 to avoid the light leaking from the second incident plane 112. Moreover, a condenser 38 is disposed between the light emitting elements 12 and the first incident plane 111 to further avoid the light leaking.

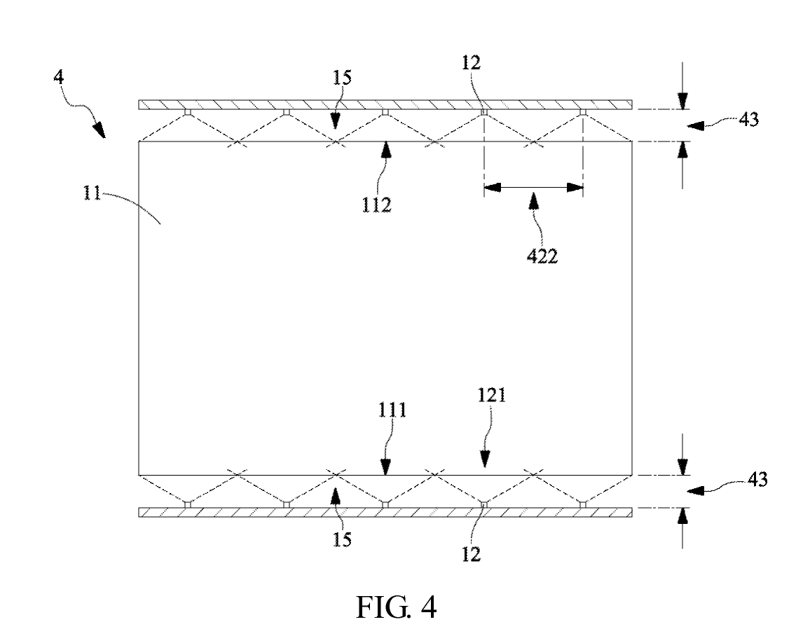

FIG. 4 is a schematic diagram showing a backlight module in a seventh embodiment of the disclosure. The difference between the seventh embodiment and the embodiments above is that a second quantity of the light emitting elements 12 are disposed at the second incident plane 112 of the light guide plate 11. The second incident plane 112 includes a second length. Moreover, each light emitting element emits light to form a specific emitting region 121. Each light emitting element is disposed at a position away from the second incident plane 112 with a second distance 43, and a second interval 422 is between each two adjacent light emitting element 12. The second interval 422 equals to the ratio of the second length to the second quantity, and its value is between eight and forty. Additionally, the non-intersection area of the emitting region 121 of any two adjacent light emitting elements 12 is outside the display area of the display.

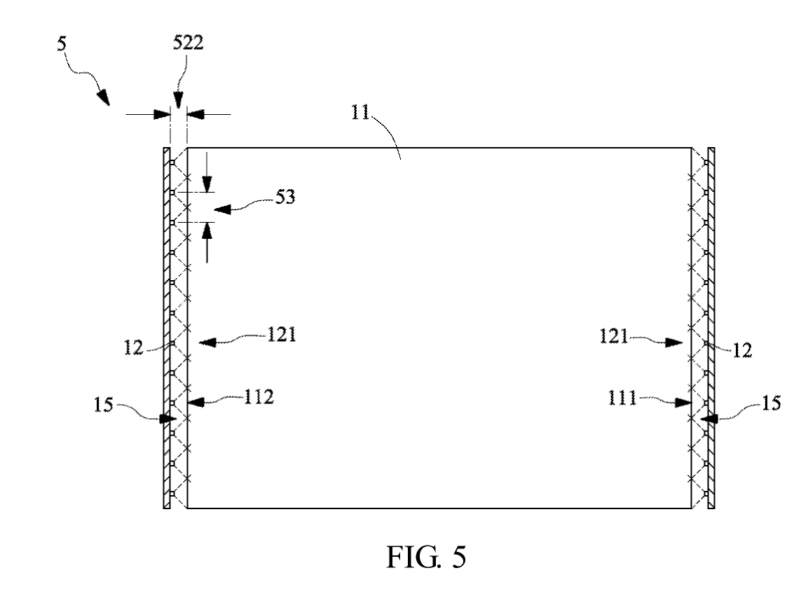

FIG. 5 is a schematic diagram showing a backlight module in an eighth embodiment of the disclosure. Compared with the fifth embodiment in which the light emitting elements 12 are disposed at the upper and the bottom sides of the light guide plate 11, the light emitting elements 12 in the eighth embodiment are disposed at the left and right sides of the light guide plate 11. The backlight module 4 in the seventh embodiment and the backlight module 5 in the eighth embodiment are even adapted to the display with a large size.

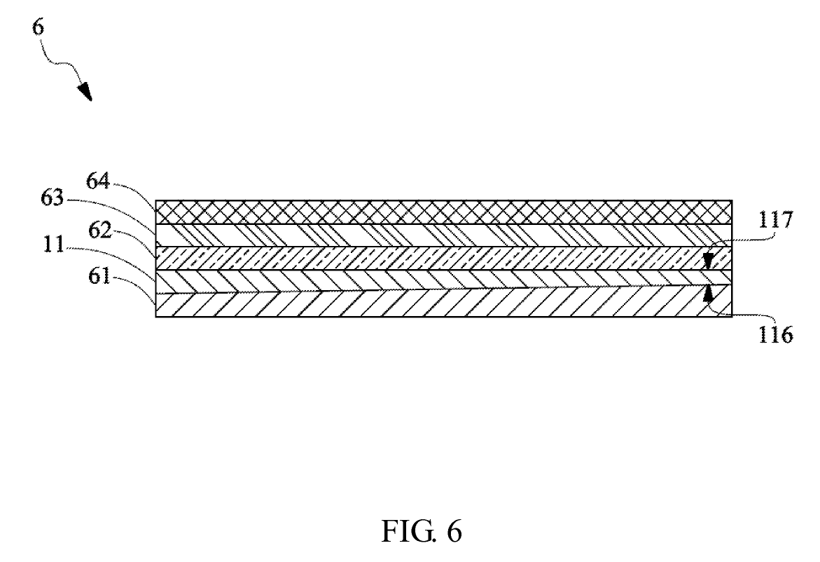

FIG. 6 is a sectional schematic diagram showing a backlight module in a ninth embodiment of the disclosure. The light guide plate 11 of the backlight module 6 in the embodiment includes a light emitting surface 117 and a back surface 116, and further includes a reflector sheet 61, a diffusion sheet 62, a prism sheet 63, a polarizer 64 and other optical elements. The reflector sheet 61 is disposed at the back surface of the light guide plate 11 to reflect the light from the light emitting elements 12 to the light emitting surface 117. The diffusion sheet 62 is disposed on the light emitting surface 117 of the light guide plate 11 to homogenize the light from the light emitting elements 12. The prism sheet 63 is disposed on the diffusion sheet 62 to adjust and centralize the divergent light to improve the whole brightness of the backlight module 6. The polarizer 64 is disposed on the prism sheet 63 to make all the light pass through the polarizer 64 be polarized light.

The embodiments above can be applied to a display device with a backlight module as a light source, such as a LCD device. The display device mainly includes a display area and a backlight module. The backlight module is disposed below the display area, and the technology features are illustrated in the embodiments above, which is omitted herein.

Furthermore, the backlight modules in the embodiments above can be further applied to an electronic device such as a notebook computer. The electronic device mainly includes a body, a display part and a backlight module. The body includes a keyboard and a motherboard. The display part is electrically connected to the body to display the information generated by the body at a display area. The backlight module is disposed at the display part and below the display area, and the technology features of the backlight module are illustrated in the embodiments above, which is omitted herein.

Although the present disclosure has been described in considerable detail with reference to certain preferred embodiments thereof, the disclosure is not for limiting the scope of the disclosure. Persons having ordinary skill in the art may make various modifications and changes without departing from the scope. Therefore, the scope of the appended claims should not be limited to the description of the preferred embodiments described above.

What is claimed is:

1. A backlight module adapted to a display including a display area, the backlight module comprising:
a light guide plate, having a first incident plane with a first length; and
a first quantity of light emitting elements, wherein each of the light emitting elements emits light to form an emitting region and is disposed at a position away from the first incident plane with a first distance, a first interval is between each two adjacent light emitting elements, the first interval equals to the ratio of the first length to the first quantity, the ratio is between eight and forty, and non-intersection area of the emitting region of the each two adjacent light emitting elements is outside the display area.

2. The backlight module according to claim 1, wherein the light guide plate comprises a second incident plane.

3. The backlight module according to claim 2, wherein the second incident plane has a second length, and the backlight module further comprises a second quantity of the light emitting elements disposed at a position away from the second incident plane with a second distance, a second interval is between each two adjacent light emitting elements of the second quantity of the light emitting elements, the second interval equals to the ratio of the second length to the second quantity, the value of the second interval is between eight and forty, and the non-intersection area of the emitting region of the each two adjacent light emitting elements of the second quantity of the light emitting elements is outside the display area.

4. The backlight module according to claim 2, further comprising:
a reflecting layer covering the second incident plane.

5. The backlight module according to claim 1, wherein the light guide plate comprises a light emitting surface and a back surface, and the backlight module further comprises:
a reflector sheet disposed at the back surface of the light guide plate;
a diffusion sheet disposed at the light emitting surface of the light guide plate;
a prism sheet disposed on the diffusion sheet; and
a polarizer disposed on the prism sheet.

6. The backlight module according to claim 1, further comprises:
a condenser disposed between the light emitting element and the first incident plane.

7. A display device, comprising:
a display area;
a backlight module disposed below the display area, comprising:
a light guide plate comprising a first incident plane with a first length; and
a first quantity of light emitting elements, wherein each of the light emitting elements emits light to form an emitting region and is disposed at a position away from the first incident plane with a first distance, a first interval is between each two adjacent light emitting elements, the first interval equals to the ratio of the first length to the first quantity, the ratio is between eight and forty, and non-intersection area of the emitting region of the each two adjacent light emitting elements is outside the display area of the display device.

8. The display device according to claim 7, wherein the backlight module further comprises:
a reflector sheet disposed at a back surface of the light guide plate;
a diffusion sheet disposed at a light emitting surface of the light guide plate;
a prism sheet disposed on the diffusion sheet; and
a polarizer disposed on the prism sheet.

9. An electronic device, comprising:
a body;
a display part electrically connected to the body and comprising a display area; and
a backlight module disposed in the display part and below the display area, comprising:
a light guide plate comprising a first incident plane with a first length; and
a first quantity of light emitting elements, wherein each of the light emitting elements emits light to form an emitting region and is disposed at a position away from the first incident plane with a first distance, and a first interval is between each two adjacent light emitting elements, the first interval equals to the ratio of the first length to the first quantity, the ratio is between eight and forty, and non-intersection area of the emitting region of the each two adjacent light emitting elements is outside the display area.

10. The electronic device according to claim 9, wherein the backlight module further comprises:
a reflector sheet disposed at a back surface of the light guide plate;
a diffusion sheet disposed at a light emitting surface of the light guide plate;
a prism sheet disposed on the diffusion sheet; and
a polarizer disposed on the prism sheet.
